(19) United States
(12) Patent Application Publication
(10) Pub. No.: US 2023/0095505 A1
(43) Pub. Date: Mar. 30, 2023

(54) CUSTOM ADVERTISING AND BRAND WRAPS FOR SMART DRONES

(71) Applicant: Michele Dicosola, Bloomingdale, IL (US)

(72) Inventor: Michele Dicosola, Bloomingdale, IL (US)

(21) Appl. No.: 17/951,091

(22) Filed: Sep. 22, 2022

Related U.S. Application Data
(60) Provisional application No. 63/246,928, filed on Sep. 22, 2021.

(51) Int. Cl. G09F 21/08; B64C 39/02; B64D 1/00; G05D 1/10; G09F 21/04; G09F 9/30; G09F 27/00; G06Q 30/02

(52) U.S. Cl. CPC G09F 21/08; B64C 39/024; B64D 1/00; G05D 1/101; G09F 21/04; G09F 9/30; G09F 27/00; G06Q 30/0265; B64C 2201/141; B64C 2201/128; B64C 29/0008

(57) ABSTRACT

A system and method for providing custom advertising and brand wraps for smart autonomous multi-modal mobile transport platforms are disclosed.

### CROSS-REFERENCE TO RELATED APPLICATIONS

This application claims priority as a Continuation-in-Part to U.S. patent application Ser. No. 16/866,484, titled “SMART DRONE ROOFTOP AND GROUND AIRPORT SYSTEM,” and filed on May 4, 2020, that itself claims priority to U.S. Provisional Patent Application No. 62/842,757, filed May 3, 2019 titled “UNIVERSAL AUTOMATED ARTIFICIAL INTELLIGENT ROOFTOP UAS/UAV DRONE PORT/AIRPORT STATION FOR GENERAL PURPOSE SERVICES OF ROBOTIC UAS/UAVS, and its SUPPORTING HARDWARE & EQUIPMENT RELATED To; LOADING/UNLOADING DELIVERIES, DEPLOYMENT/ARRIVAL, DISPATCHING, AIR TRAFFIC CONTROL, CHARGING, STORING/GARAGING, DE-ICING/ANTI-ICING, METEOROLOGICAL & DATA DISSEMINATION/RETRIEVAL, BIG DATA MINING, AND MIMO NETWORK SERVICES.” These applications are incorporated herein by reference in their entirety.

This application is also related to the following concurrently filed United States patent applications: a. U.S. patent application Ser. No. ______, filed November ______, 2020, titled “SMART DRONE/UNMANNED AERIAL VEHICLE (UAV/VTOL) MODULAR CONTAINER FOR FIXED AND DISPOSABLE CONTAINERS,” Attorney Docket No. GIPL 2177.002-US-01; b. U.S. patent application Ser. No. ______, filed November ______, 2020, titled “______,” Attorney Docket No. GIPL 2177.003-US-01; and U.S. patent application Ser. No. ______, filed November ______, 2020, titled “______,” Attorney Docket No. GIPL 2177.004-US-01. These applications also are incorporated herein by reference in their entirety.

### TECHNICAL FIELD

This application relates in general to a system and method for providing unmanned aerial vehicles, unmanned vehicle operating systems, and airport facilities thereof, and more specifically, to a system and method providing custom advertising and brand wraps for smart autonomous multi-modal mobile transport platforms.

### BACKGROUND

Smart autonomous multi-modal mobile transport platforms, autonomous flying devices, and similar unmanned vehicles are being developed to perform delivery tasks for vendors of all kinds, including retail establishments, restaurants, and related food service providers. Systems employing these autonomous flying devices are being integrated into larger systems that may include point-of-sale components, autonomous flying devices dispatch, routing, and control components, such that these systems may be provided as a service to business establishments as needed.

The autonomous flying devices in some embodiments may be used to support more than one business such that branding of items being delivered may change over time. Many businesses may desire to include specific logos, example products, and related branding on the autonomous flying devices that deliver their products. Having an ability to control and alter the appearance of the autonomous flying devices for a particular delivery may enhance the value of the use of these autonomous flying devices to deliver products on behalf of business establishments.

Therefore, a need exists for providing custom advertising and brand wraps for smart autonomous multi-modal mobile transport platforms. The present invention attempts to address the deficiencies and limitations of existing solutions according to the principles and example embodiments disclosed herein.

### SUMMARY

In accordance with the present invention, the above and other problems are solved by providing a system and method for providing custom advertising and brand wraps for smart autonomous multi-modal mobile transport platforms according to the principles and example embodiments disclosed herein.

In one embodiment, the present invention is a system for providing custom advertising and brand wraps for smart autonomous multi-modal mobile transport platforms.

In another embodiment, the present invention is a method for providing custom advertising and brand wraps for smart autonomous multi-modal mobile transport platforms.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates a system for providing custom advertising and brand wraps for smart autonomous multi-modal mobile transport platforms according to the present invention.

FIG. 2a is a block diagram illustrating an exemplary hardware architecture of a computing device.

FIG. 2b is a block diagram illustrating an exemplary logical architecture for a client device according to the present invention.

FIG. 2c is a block diagram showing an exemplary architectural arrangement of clients, servers, and external services according to the present invention.

FIG. 2d is another block diagram illustrating an exemplary hardware architecture of a computing device according to the present invention.

FIG. 3 illustrates an example embodiment of a system providing custom advertising and brand wraps for smart autonomous multi-modal mobile transport platforms according to the present invention.

FIGS. 4a-b illustrate an example embodiment of a smart autonomous multi-modal mobile transport platform landing station for a system providing custom advertising and brand wraps for smart autonomous multi-modal mobile transport platforms according to the present invention.

FIGS. 5a-b illustrate an example embodiment of a smart autonomous multi-modal mobile transport platform with custom advertisements in a system providing custom advertising and brand wraps for smart autonomous multi-modal mobile transport platforms according to the present invention.

FIG. 6 illustrates an example embodiment of a smart autonomous multi-modal mobile transport platform with custom advertisements on removable storage containers used by smart autonomous multi-modal mobile transport platforms according to the present invention.

FIG. 7 illustrates a computing system of software components of a system providing custom advertising and brand wraps for smart autonomous multi-modal mobile transport platforms according to the present invention.

FIG. 8 illustrates a flowchart corresponding to a method performed by software components of a system providing custom advertising and brand wraps for smart autonomous multi-modal mobile transport platforms according to the present invention.

### DETAILED DESCRIPTION

This application relates in general to a system and method for providing unmanned aerial vehicles, unmanned vehicle operating systems, and airport facilities thereof, and more specifically, to a system and method providing custom advertising and brand wraps for smart autonomous multi-modal mobile transport platforms according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “individual” and “user” refer to an entity, e.g., a human, using a system providing custom advertising and brand wraps for smart autonomous multi-modal mobile transport platforms including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or a wireless connection(s) using any type of frequency/frequencies or radio wave(s). Some examples are included below in this application.

The term “invention” or “present invention” refers to the invention being applied for via the patent application with the title “Custom Advertising and Brand Wraps for Smart Autonomous multi-modal mobile transport platforms.” Invention may be used interchangeably with advertising and brand wraps.

The terms “communicate,” or “communication” refer to any component(s) connecting with any other component(s) in any combination for the purpose of the connected components to communicate and/or transfer data to and from any components and/or control any settings.

As used herein, the term “vehicle” may be used to describe unmanned vehicles configured to operate via ground, air, and marine modes of transportation and combinations thereof, including by way of non-limiting examples: unmanned aircraft systems (UASs), unmanned aircraft vehicles (UAVs), vertical take-off and landing vehicles (VTOLs), electric vertical take-off and landing vehicles (eVTOLs), vertical short take-off and landing vehicles (VSTOLs), short take-off and landing vehicles (STOLs), electric take-off and landing vehicles (eSTOLs), conventional takeoff and landing vehicles (CTOLs), autonomous vehicles (AVs), connected and autonomous vehicles (CAVs), passenger air vehicles (PAVs), electric passenger air vehicles (ePAVs), heliports, vertiports, and the like. One skilled in the arts will readily understand that various additional forms of land-operating vehicles, aircraft, watercraft, railcars, and the like may be utilized with the embodiments provided herein.

For the purposes of the disclosure, though describing an example definition and not a limiting definition, a “state channel” refers to a technique designed to allow users to make multiple blockchain transactions such as state changes or money transfers, without committing all of the transactions to the blockchain. In the traditional state channel, only two transactions are added to the blockchain, but an infinite or almost infinite number of transactions can be made between the participants. A state channel is a smart-contract that enforces predefined rules for off-chain transactions. Each transaction creates a new state based on the previous state, signed by each party, which is cryptographically provable on the blockchain.

For the purposes of the disclosure, though describing an example definition and not a limiting definition, a directed acyclic graph (DAG) is a directed graph with no directed cycles. That is, it consists of vertices and edges (also called arcs), with each edge directed from one vertex to another, such that following those directions will never form a closed loop. A directed graph is a DAG if and only if it can be topologically ordered, by arranging the vertices as a linear ordering that is consistent with all edge directions.

For the purposes of the disclosure, though describing an example definition and not a limiting definition, “Hypergraph T Protocol” (“HGTP”) refers to a distributed ledger technology known as a directed acyclic graph (DAG) protocol with a novel reputation-based consensus model called Proof of Reputable Observation (PRO). Hypergraph is a feeless decentralized network that supports the transfer of $DAG cryptocurrency. The Hypergraph network is made up of a collection of microservices called state channels. Each state channel validates specific data types with user-defined validation functions. State channels form a distributed network architecture that can accommodate real world big data use cases. Developers can integrate state channels directly into existing applications, allowing for direct E2E security and minimal seamless deployment.

For the purposes of the disclosure, though describing an example definition and not a limiting definition, a “smart contract” may be a computer program, algorithm, sequence steps or a transaction protocol which is intended to automatically execute, control or document legally relevant events and actions according to the terms of a contract or an agreement.

For the purposes of the disclosure, though describing an example definition and not a limiting definition, a “blockchain” may be a type of central or decentralized digital ledger technology implemented in a computer program, storage medium containing instructions or a non-transitory signal and that consists of a growing list of records, called blocks, that are securely linked together using cryptography. Each block contains a cryptographic hash of the previous block, a timestamp, and transaction data (generally represented as a Merkle tree, where data nodes are represented by leafs). The timestamp proves that the transaction data existed when the block was created. Since each block contains information about the block previous to it, the blocks effectively form a chain, with each additional block linking to the ones before it. Blockchain transactions are intended to be irreversible in that, once they are recorded, the data in any given block cannot be altered retroactively without altering all subsequent blocks.

For the purposes of the disclosure, though describing an example definition and not a limiting definition, the term “non-fungible tokens” (NFTs) refers to digital instruments that will allow for data suppliers and data creators to take their data that would normally be tossed away after an inspection, surveillance or delivery for example, and either direct stream the data into the exchange database depository or repository and “purpose” the raw validated data and or “repurpose” the raw and or modeled verified data, to be used within the smart self-healing node centric mesh network of blockchain-based on a data exchange as data creators, producers and or suppliers start to develop photo images, videos and/or models, such as digital twin cities, that they can for example wish to sell, lease and/or license, data that can be provided to the buyer, user, acquirer, but where the creators, producers and or have decided to declare it as an original, unique, and one-of-a-kind digital data work product, that they will not reproduce, they will be able to do so via the NFT portion of the self-healing blockchain-based data exchange.

For the purposes of the disclosure, though describing an example definition and not a limiting definition, the term “non-fungible rights” (“NFR) refers to dynamic negotiating on a creator/distributor/producer and buyer/user/acquirer who use their own front and backend administrative dashboard interfaces (UI) and (UX), that allow the user to query data they are looking for and for the seller then can make custom dynamic real time or post time offers. This can go back and forth dynamically to create a Layer_0 or Layer_1 NFR smart contract that has the custom terms and conditions for the same digital asset, which can be used again by the data owner with separate and different terms and conditions with another buyer/user/acquirer. This becomes a backend oracle that can be used to create these custom smart contracts through a Web3 state channel on the front-end UI and UX interface on Hypergraph Web3, HGTP, DAG, LTX and L_0 and or Layer 1 networks as a State Channel and or Smart Contract. NFRs allow one to pay and or use rewards of crytpo/tokens for bandwidth, data and or other forms of agreements and or payment and payment terms and conditions.

For the purposes of the disclosure, though describing an example definition and not a limiting definition, the term “Digital Data Bundle of Rights™” refers to the digital data bundle of rights that provide for rights and or privileges that can be divided by use, terms, and ownership, among other privileges and rights. The disclosure provides for a back-office dashboard where a data supplier can provide data that is assigned specific terms that will allow for a data acquisition user to agree to. For example, a data supplier may upload an NFT and state that a 72 DPI image can be purchased outright for a certain price, but 300 DPI is only available by lease for a limited time. That same file can provide for the option to buy the data as HD quality, but only if it is used for a digital twin project that will provide for royalty licensing rights. The file also can provide for fractional ownership of the NFT if it is 1200 DPI. The data supplier could even reserve anything that is 600 DPI for a charitable donation and still use the same 600 DPI as only available as a touch point licensing on IoT-only hardware. Determining the Digital Data Bundle of Rights© for terms and conditions of the digital data use and/or ownership will be limited to the imagination and capability of the data. The dashboard will be scalable as the terms evolve. The type of data and/or use of data is agnostic and interoperable. Any data is monetizable or can be provided for free: dynamic and or static data, data types, files, formats, video, audio, communication frequencies, spectrums, etc.

For the purposes of the disclosure, though describing an example definition and not a limiting definition, the term “NFT Bundle of Rights™ (NFTBOR)” refers to taking a piece of that NTF bundle for various uses. For example, users may want to keep the use of the land, but sell the mineral rights. Users may want to lease the land itself. If a user has declared an original digital data as something the user will not reproduce and want it to be sold as an NFT, that data is the user's property to do with it as he/she would any piece of real estate. However, old NFTs simply allow for the data to be sold off in pieces under smart contracts with fractional or full token share sales and purchases and or limited rules. A user could take a digital photo for example and offer it for sale, lease and/or license or create any terms and conditions agreeable between parties. Users can take that even further by saying that the NFT can be free to the public for one purpose and/or use, but must be purchased for another use and leased for even another. Users can even make them options and/or licensing rights with a balloon expiration date. This maximizes the NFT monetization and or subsidization opportunity to its fullest. There is no limit to the types of digital data one can use as an NFT and declare as a NFTBOR asset. This maximizes the NFT monetization opportunity to its fullest. There is no limit to the types of digital data one can use as an NFT and declare as a NFTBOR asset.

For the purposes of the disclosure, though describing an example definition and not a limiting definition, “digital currency” refers to currency, money, or money-like asset that is primarily managed, stored or exchanged on digital computer systems, especially over the internet. Types of digital currencies include cryptocurrency, virtual currency and central bank digital currency. Digital currency may be recorded on a distributed database on the internet, a centralized electronic computer database owned by a company or bank, within digital files or even on a stored-value card.

For the purposes of the disclosure, though describing an example definition and not a limiting definition, “cryptocurrency,” sometimes called crypto-currency or crypto, is any form of currency that exists digitally or virtually and uses cryptography to secure transactions. Cryptocurrencies don't have a central issuing or regulating authority, instead using a decentralized system to record transactions and issue new units.

Cryptocurrency is a digital payment system that does not rely on banks to verify transactions. It is a peer-to-peer system that can enable anyone anywhere to send and receive payments. Instead of being physical money carried around and exchanged in the real world, cryptocurrency payments exist purely as digital entries to an online database describing specific transactions. When you transfer cryptocurrency funds, the transactions are recorded in a public ledger. Cryptocurrency is stored in digital wallets.

For the purposes of the disclosure, though describing an example definition and not a limiting definition, a “digital wallet,” also known as an e-wallet, is an electronic device, online service, or software program that allows one party to make electronic transactions with another party bartering digital currency units for goods and services. This can include purchasing items either online such as on Web3 and MainNet 2.0 or at the point of sale in a brick-and-mortar store, using either mobile payment (on a smartphone or other mobile device) or (for online buying only) using a laptop or other personal computer. You can use the touchless wand capabilities to make payments as well through your mobile device's application. Money can be deposited in the digital wallet prior to any transactions or, in other cases, an individual's bank account can be linked to the digital wallet. Users might also have their driver's license, health card, loyalty card(s) and other ID documents stored within the wallet. The credentials can be passed to a merchant's terminal wirelessly via near field communication (NFC). A digital wallet may be used for Carbon Credit Gift Card/Crypto Giftcard/Token Gift Cards; to load, reload, airdrop to other digital wallets or keep them in a digital wallet for use with vendors, government agencies and or other promotional opportunities.

For the purposes of the disclosure, though describing an example definition and not a limiting definition, the term “Smart Self-Healing Node Centric Mesh Inverted Aggregated Data Architecture Network on the blockchain-based data exchanges” refers to a data storage device that stores data received for long term usage onto a blockchain distributed ledger using blockchain processing. The data ledger is maintained on a plurality of universal computing nodes as is common in all blockchain processors. These computing nodes are disclosed herein as being interconnected over a distributed computing network using standard data communications protocols. One skilled in the art will recognize that the blockchain ledgers being maintained by multiple universal computing nodes also may be implemented with other comparable communications and secure storage technologies including a L_0 (level zero) and Layer 1 distributed network, an HGTP (hypergraph transfer protocol) network, and any other network configuration and protocol.

For the purposes of the disclosure, though describing an example definition and not a limiting definition, the term “L_0 distributed network” refers to existing cryptocurrency token standards and decentralized layer 1 protocols such as Ethereum (ETH) and DisCas Vision (DISC) which have high slow latency and vastly fluctuating and high gas fees (transaction fees) to use their networks. The historic data cannot be created at its original source because the data validators in ETH are not providing the full historic blockchain data creation events, when using Proof of Work (PoW) and Proof of Stake (PoS) metrics, which contributes to the high gas fees and latency associated with the various networks. Using this older method, the business models' cost and profit predictability become uncertain for DISC and ETH to produce commercially sustainable and viable blockchain validated and trusted data such as that provided by using a smart self-healing node centric blockchain mesh network, Autonomous Multi-Modal Data Infrastructure, and the autonomous mobility data exchange (AMX)/sub-exchange. This high data latency fluctuation and gas fee dilemma can be solved by a system minting an L_0 token using an HGTP hypergraph network that is a decentralized L_0 protocol network, which requires zero transaction fees, built as a high-volume transaction utility and use cases, with lower latency and scalable solutions. The hypergraph network is built with concurrent consensus mechanisms and is structured using a directed acyclic graph (DAG) for high bandwidth and throughput needs, thereby allowing for the creation of a scalable business model and metric on top of the hypergraph by attaching a transaction fee to various products, services, and solutions without the cost of layer 1 transaction fees. A crypto user base customer who entered the self-healing blockchain-based data exchange(s) and the hypergraph network, out of layer 1 networks like ETH, will be able to navigate through the smart self-healing node centric blockchain mesh network, the hypergraph network, and associated AMX and lattice exchanges and state channels.

For the purposes of the disclosure, though describing an example definition and not a limiting definition, the term “data agnostic” refers to allowing for all types of industry-accepted data formats to be universally accepted in the node network. The smart self-healing node centric blockchain mesh network offers a delivery drone app and data exchange that is hardware/software agnostic on an interoperable, scalable, and open platform.

For the purposes of the disclosure, though describing an example definition and not a limiting definition, an “HGTP horizontal hypergraph” requires projects to create liquidity and bandwidth pools to access the network and create liquidity of L_0 tokens. The disclosure requires liquidity and bandwidth support for its smart delivery drone mobile application for both manual and autonomous multi-modal transportation. Through a staking and or rewards program, the disclosure provides liquidity providers rewards with tokens as APY.Finance tokens. The Platform Community Token Rewards program will be used to support the liquidity pool. As a data provider onboards, for example, a traditional and non-traditional manual and autonomous smart drone data miners, smart landing pad data miners™, smart mailbox landing pad data miners™, smart charging station data miners, smart container data miners, smart delivery doorbell and chime data minder©, UGV, robot, eVTOL, UMV, sensor with data mining, mobile driver and user apps as a software and hardware node to the network, the needed throughput on the hypergraph network will be increased and supported. It will be scalable, modular and agnostic for data, cross-chain, and cross-chain liquidity with NFT, NFR, Web3, crypto and token minting through state channels. The disclosure provides these node solutions through its smart self-healing node centric blockchain mesh network with inverted aggregated data architecture integrated with cyber inflation, processing and data applications, in collaboration with the Hypergraph network. The cross-connection of the nodes communicating also allows for AIML.

For the purposes of the disclosure, though describing an example definition and not a limiting definition, a “utility token” refers to a crypto token that serves some use case within a specific ecosystem. These tokens allow users to perform some action on a certain network.

For the purposes of the disclosure, though describing an example definition and not a limiting definition, a “security token” refers to a unique token issued on a permissioned or permissionless blockchain, representing a stake in an external asset or enterprise. Entities like government and businesses can issue security tokens that serve the same purpose as stocks, bonds and other equities.

For the purposes of the disclosure, though describing an example definition and not a limiting definition, the term “digital twins” refers to the digital twin model of user's data, that will subsidize and or monetize the value of it via the AMX as markets start to understand the value of this digital data.

For the purposes of the disclosure, though describing an example definition and not a limiting definition, the term “metaverse” refers to an artificial digital environment that will provide for entire cities, small size-towns, countries, and worlds. This can be sold on the AMX data exchange.

For the purposes of the disclosure, though describing an example definition and not a limiting definition, the term “smart shipping container and nodes” refers to autonomous air, ground and marine vehicles that will eventually be required to monitor and log all internal and external activity related to a transported container for safety and security. Containers come in all shapes and sizes. The smart self-healing node centric blockchain mesh network looks as these transportation multimodal opportunities to evolve the containers into Smart Shipping Containers, Smart Cargo Containers, Smart Drone Containers, Smart Truck Containers, Smart Train Containers, Smart VTOL Containers, Smart Marine Containers, Smart Boat Containers, Smart Car Containers, Smart Travel Containers, etc., that allow for security, security risk assessment, situational awareness, content monitoring, and observation and memorialization using sensor data both inside and outside of the container.

An HGTP horizontal hypergraph requires projects to create liquidity and bandwidth pools to access the network and create liquidity of L_0 tokens. The disclosure requires liquidity and bandwidth support for its smart delivery drone mobile application. Through a staking program, the disclosure provides liquidity providers rewards with tokens as APY.Finance tokens. The Platform Community Token Rewards program will be used to support the liquidity pool. As a data provider onboards, for example, a traditional and non-traditional manual and autonomous smart drone, smart landing pad™, smart mailbox landing pad™, smart charging station, smart container©, UGV, robot, eVTOL, UMV, sensors, mobile driver and user apps as a hardware node to the network, the needed throughput on the hypergraph network will be increased and supported. The disclosure provides these node solutions through its smart self-healing node centric blockchain mesh network in collaboration with the Hypergraph network. The cross-connection of the nodes communicating also allows for AIML.

For the purposes of the disclosure, though describing an example definition and not a limiting definition, “Web2” means an iteration of the World Wide Web as a platform of services including user-created content uploaded to forums, social media and networking services, blogs, and wikis, among other services.

For the purposes of the disclosure, though describing an example definition and not a limiting definition, “Web3” means an iteration of Web2 as a decentralized online ecosystem based on blockchain. Web3 represents a combination of decentralized or federated platforms, secured interoperability, and verifiable computing through distributed ledger technologies

In general, the present disclosure relates to a system and method for providing custom advertising and brand wraps for smart autonomous multi-modal mobile transport platforms.

The disclosed smart autonomous multi-modal mobile transport platform system is part of a decentralized multi-modal autonomous mobile transport platform infrastructure, seamlessly connecting people and vendors to smart mobile hailing apps, smart rooftop drone airports, smart landing pad miners and smart doorbell miners. The disclosed smart autonomous multi-modal mobile transport platform system provides smart autonomous multi-modal mobile transport platforms and smart mobile transport platform charging and launching stations, with weather sensors, data and other auxiliary sensors, to additionally provide surveillance security, artificial intelligence/machine learning, cyber security for travel, take-off, landing, charging in air or on direct landing on a landing pad. The disclosed smart autonomous multi-modal mobile transport platform airport system allows for modulation, scalability, interoperability of drone hardware, data and software agnostic services and applications. The disclosed system enables the use of a smart autonomous multi-modal mobile transport platform to display advertisements or brand marks on available surfaces of the smart autonomous multi-modal mobile transport platform or on a container attached thereto. The advertisements and brand marks may be dynamic or static presentations, displayed on display screens on the smart autonomous multi-modal mobile transport platform. In addition, the smart autonomous multi-modal mobile transport platform may allow placement of physical icons or articles and digital icons or articles. The smart autonomous multi-modal mobile transport platform may allow an airdrop of a physical or digital package to a waiting customer. The smart autonomous multi-modal mobile transport platform may display one or more advertising messages or one or more brand marks on a display monitor attached to the smart drone autonomous multi-modal mobile transport platform or a modular smart container attached to the autonomous multi-modal mobile transport platform. The autonomous multi-modal mobile transport platform may send a push notification to the customer, where payment for the one or more advertising messages or the one or more digital brand marks can be made by credit card payment, fiat payment, a digital wallet with cryptocurrency and/or tokens for payment in addition to credit cards and fiat payments, and redemption of a delivered advertisement, promotional messages and/or digital coupons are stored in the digital wallet and/or used at a different time. Moreover, participating mobile devices in the system can receive the same ad on their mobile device that is on the digital monitor that offers digital, video, audio, dynamic and static advertising with its built-in monitor(s) and or decals.

The smart autonomous multi-modal mobile transport platform may include an unmanned aircraft system (UAS), an unmanned aircraft vehicle (UAV), a vertical take-off and landing vehicle (VTOL), electric vertical take-off and landing vehicle (EVTOL), a vertical short take-off and landing vehicle (VSTOL), a short take-off and landing vehicles (STOL), an electric take-off and landing vehicle (eSTOL), a conventional take-off and landing vehicle (CTOL), an electric take-off and landing vehicle (eCTOL), an autonomous vehicles (AV), a connected and autonomous vehicles (CAV), a passenger air vehicle (PAV), or an electric passenger air vehicle (ePAV), a robotic UAV/UAS, UGVs, an autonomous ground transport vehicles or a ground robotic platform. The autonomous multi-modal mobile transport platform may also provide transportation of items and services by marine delivery, ground delivery and/or air autonomous drones and/or a manually-controlled drone. The disclosed smart autonomous multi-modal mobile transport platform also may be enabled and controlled by an app or software or applications.

The disclosed smart autonomous multi-modal mobile transport platform airport system provides an autonomous multi-modal infrastructure ecosystem that is open platform, that is scalable, modular, interoperable, agnostic on blockchain, enabled by hypergraph HGTP Web3 protocols running on the L_0 layer, avoiding gas fees that may arise in other layers. The disclosed autonomous multi-modal mobile transport platform airport system is enabled by edgeless cloud at the edge of the hypergraph associated with the disclosed system.

The disclosed smart autonomous multi-modal mobile transport platform airport system is enabled and improved with an artificial intelligence/machine learning model interfaced to the disclosed autonomous multi-modal mobile transport platform airport system, along with a cybersecurity-enhanced point-of sale systems (PoS) with a cross-platform liquidity and cross-blockchain liquidity for minting, exchange, validating data and metadata associated with users of the autonomous multi-modal mobile transport platform airport system allowing seamless transfers of cryptocurrencies, token, digital wallets, Web2 applications and Web3 applications, all directed and controlled by a mobile app for mobile device, such as smart televisions, smart phones, tablets and other mobile devices, all allowing validation of data and metadata to produce immutable data on a blockchain ledger that will propagate through the network.

Other aspects of the disclosure provides a artificial intelligence module operable to determine an optimum route for a smart autonomous multi-modal mobile transport platform based on weather conditions associated with the route; air traffic associated with the route; indications of no-fly zones associated with the route; availability of the smart autonomous multi-modal mobile transport platform for delivery of the payload, operating conditions of the smart mobile transport platform; delays associated with onboarding and unloading of the payload on the smart mobile transport platform, information associated with emergency announcements, missing person alerts or crime notification warnings, along with emergency announcements, celebratory events, disease quarantines, “shelter-in-place” warnings, wanted ads, missing ads, products, services, vacation ads as just a few examples.

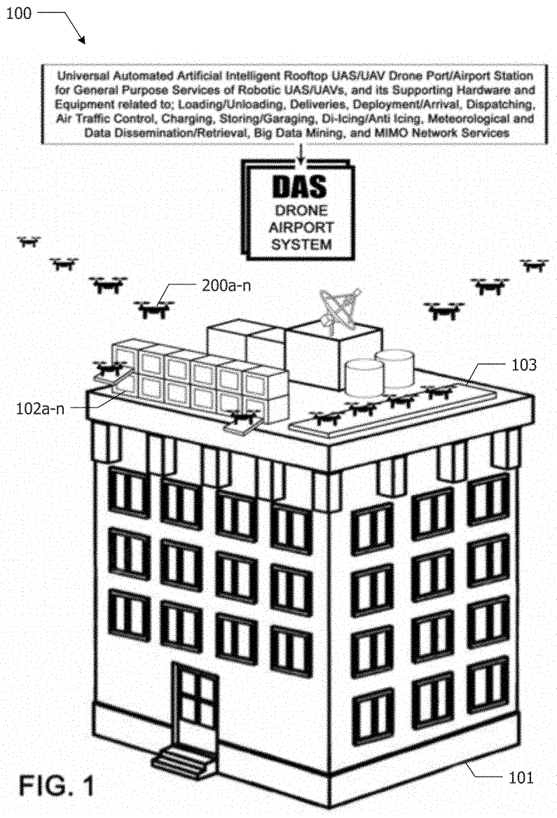

To better understand the present invention, FIG. 1 illustrates a system for providing custom advertising and brand wraps for smart smart autonomous multi-modal mobile transport platforms according to the present invention. The present invention discloses custom advertising and brand wraps for smart smart autonomous multi-modal mobile transport platforms that is part of a larger system having a UAS/UAV rooftop smart autonomous multi-modal mobile transport platform-port/airport, comprising charging, de-icing, anti-icing, storing and parking garage/hanger services, which provide the following capabilities: autonomous multi-modal mobile transport platform-on-demand delivery services; smart autonomous multi-modal mobile transport platforms parked, stored, and/or charging in the smart autonomous multi-modal mobile transport platform garage and/or on a smart autonomous multi-modal mobile transport platform landing pad; orders made via mobile, land, and TV applications using wired and/or wireless connections; smart autonomous multi-modal mobile transport platform AI (artificial intelligence) Cloud determines if weather permits delivery to and from the location requested at the time requested; and smart autonomous multi-modal mobile transport platform AI Cloud determines smart autonomous multi-modal mobile transport platform availability using the fastest, most convenient, safest, and properly equipped smart autonomous multi-modal mobile transport platform for the weather conditions, payload requirements, and any other specific demand option(s). In addition the smart autonomous multi-modal mobile transport platform may consider weather conditions associated with the route; air traffic associated with the route; indications of no-fly zones associated with the route; availability of the smart autonomous multi-modal mobile transport platform for delivery of the payload, operating conditions of the smart mobile transport platform; delays associated with onboarding and unloading of the payload on the smart mobile transport platform, information associated with emergency announcements, missing person alerts or crime notification warnings, along with emergency announcements, celebratory events, disease quarantines, “shelter-in-place” warnings, wanted ads, missing ads, products, services, vacation ads to determine an optimum route. The overall system is disclosed in detail in reference to FIGS. 1-4 discussed below.

The Unmanned Aircraft System Traffic Management (UTM) deploys the autonomous multi-modal mobile transport platform to the landing pad 103 for loading/unloading, drop off, and pickup. The autonomous multi-modal mobile transport platform is loaded and departs to its destination. The autonomous multi-modal mobile transport platform arrives at its destination, confirms the receiver of the package, releases the product to the consumer, and informs the POS that the order has been delivered. The autonomous multi-modal mobile transport platform AI then selects either the autonomous multi-modal mobile transport platform's next destination based upon its remaining battery use, and sends it to its next order, or it parks the autonomous multi-modal mobile transport platform at the nearest autonomous multi-modal mobile transport platform airport parking station where it can recharge and wait for further instructions.

All rooftop UAS/autonomous multi-modal mobile transport platform hardware 200a-n exterior and/or interior equipment 102 and landing pad equipment 103 will have a waterproof option such as superhydrophobic (water) and oleophobic (hydrocarbon) coating, that will completely repel almost any liquid, and/or nanotechnology coating, to coat the autonomous multi-modal mobile transport platform and create a barrier of air on its surface.

All UAS/autonomous multi-modal mobile transport platforms that deploy will have the option to use UAS/UAV de-icing inflatable boot equipment on the leading and trailing edges of the propeller arm(s). All UAS/autonomous multi-modal mobile transport platform hardware will have impact protection options, using products like Mashable D30 Crystalex clear, formable elastomer material as protective gear on the UAS/autonomous multi-modal mobile transport platforms for drop test crash resistance.

All UAS/autonomous multi-modal mobile transport platform hardware will have nanocrystalline metal alloy options for a lighter, stronger, and more efficient UAS.

The Smart Autonomous multi-modal mobile transport platform Airport System (SDAS) has been designed to provide options for the following services: 1) less than load delivery (LTL); 2) document delivery services; 3) distribution center delivery; 4) freight on board (FOB) delivery; cost, insurance, and freight (CIF) delivery; 5) cost, no insurance, freight (CNF) delivery; 6) rideshare package delivery; 7) rideshare person delivery; 8) ride hailing; 9) on-demand location- and service-based UAS/autonomous multi-modal mobile transport platform hiring; 10) private and public use hiring; 11) take away delivery; 12) parking, storing, garaging, charging, de-icing, anti-icing, and docking; 13) warehousing delivery; 14) customs and port security delivery drop offs; 15) perishable and non-perishable foods and product delivery; and 16) special product temperature and packaging deliveries such as medications, specimens, lab testing kits, and test results; and delivery of a person and/or cargo.

As shown in FIG. 1, the SDAS is illustrated operating from the rooftop of a commercial building. Visible are two rows of stackable, autonomous multi-modal mobile transport platform garage systems, two liquid tanks containing the de-icing/anti-icing agent, landing pad, radar system, and communications system. The airport also contains a autonomous multi-modal mobile transport platform loading/unloading landing pad station system, which may be used for manual battery swaps and as a cleaning station.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

This new invention also has the ability to manage, control or communicate with multiple or unlimited number of smart autonomous multi-modal mobile transport platforms and their billboard display devices from one or more server or computer system locations without the intervention of the operator or operators or anyone with access or privileges to use this new invention. A smart autonomous multi-modal mobile transport platform app may be used by a customer or end user to control and drive the autonomous multi-modal mobile transport platform. For example, one or more smart autonomous multi-modal mobile transport platforms and their billboard display devices can be managed or controlled or communicated with one or more servers, computer systems, or smart devices from one or more locations. To further exemplify, the user will be able to control or communicate with as many smart autonomous multi-modal mobile transport platforms and their billboard display devices as desired from one centralized location if desired or more than one location.

While all of the above functions are described to be provided to users via a mobile application on a smartphone, one of ordinary skill will recognize that any computing device including tablets, laptops, and general-purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones, laptop computers, tablets, and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

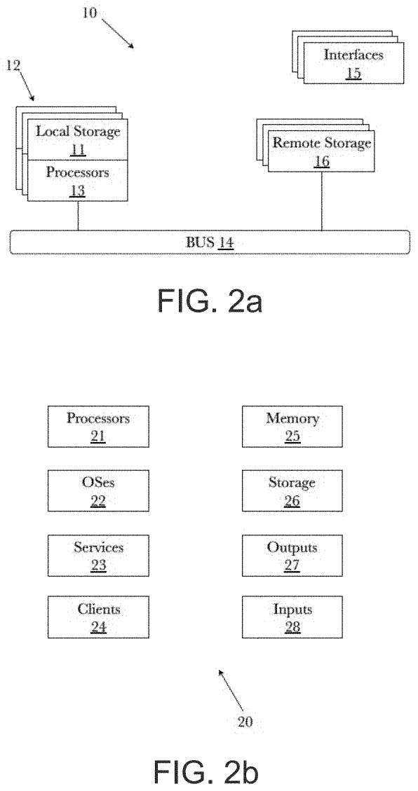

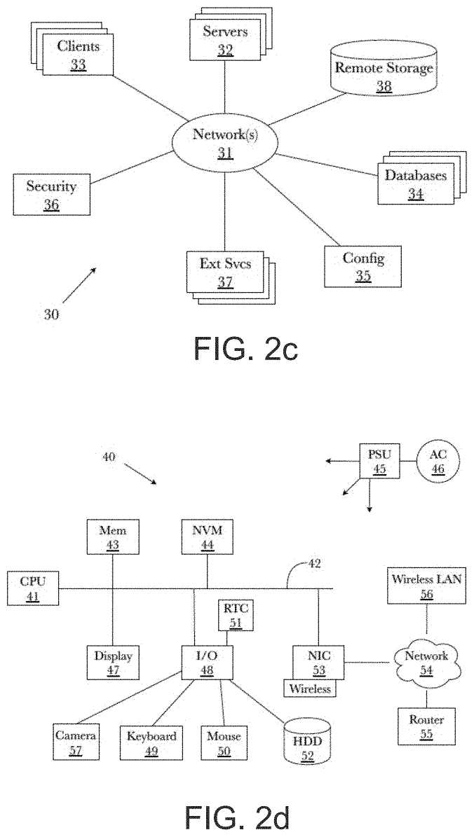

Referring now to FIG. 2a, there is a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPUs) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects of the present invention, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example, a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects of the present invention, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects of the present invention, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects of the present invention, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, non-volatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

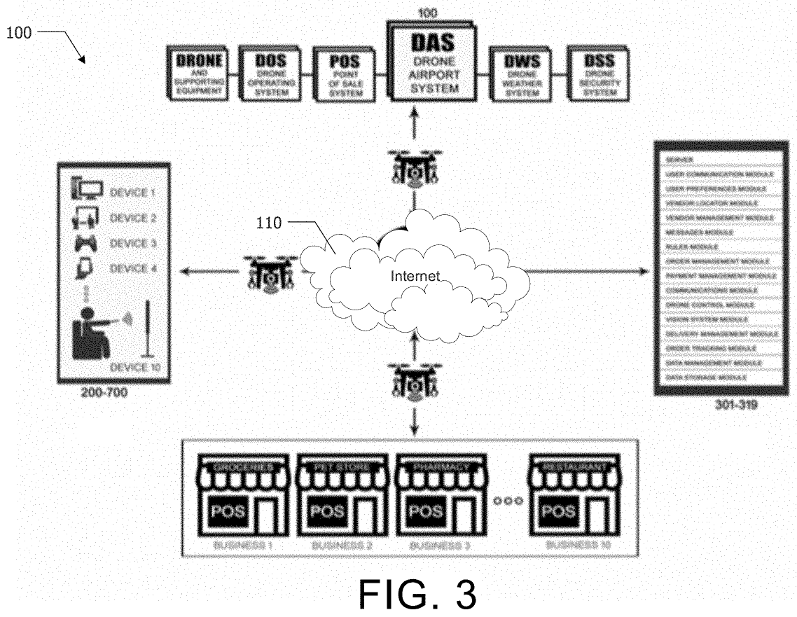

FIG. 3 illustrates an example embodiment of a system providing custom advertising and brand wraps for smart autonomous multi-modal mobile transport platforms according to the present invention. As shown in FIG. 3, the SDAS relies on a fast, cloud-based Unmanned System Service Network (USSN) consisting of nodes and services, using but not limited to, GPS, Massive MIMO 4G or 5G, and 4G or 5G LTE to maintain constant and reliable communications with autonomous multi-modal mobile transport platforms and other interactive components, such as business entities and end-user wired/wireless communication devices. The network also must be able to maintain a reliable connection with the server and be compatible with various supportive systems including the autonomous multi-modal mobile transport platform operating system, point of sale system (POS), autonomous multi-modal mobile transport platform weather system, autonomous multi-modal mobile transport platform security system, smart autonomous multi-modal mobile transport platform mailbox landing pad system, and smart landing pad system.

Every object on the DOS, SDAS, and USSN systems as an embodiment is a node and every node has the following equipment: 4G, 4G LTE and 5G LTE antenna(s), WiFi antenna, Raspberry Pi or similar SoC computer that can be programmed, a flash card for storage, an IP identifier and serial number such as a smart autonomous multi-modal mobile transport platform landing pad that shall have an address that matches the physical address of the fixed, stationed landing pad. Every node will have the following characteristics: Node types consist of the autonomous multi-modal mobile transport platform, battery, point-of-sale (POS), rooftop, smart mailbox landing pad, smart delivery container, smart charging/hanger station, and landing pads, etc.; Sector types—will be for special-purpose applications like medical delivery or law enforcement, etc.; unique 160 ID encryption; public-private key pair; public-key certificate; primary status (available or unavailable); secondary status (additional details); event log; and schedule of commitments. Every Node has access to the following services: NextGen weather data streams; ADS-B data exchange; GPS; autonomous multi-modal mobile transport platform flight planner (DFP); autonomous multi-modal mobile transport platform data exchange (DDE); autonomous multi-modal mobile transport platform system state (DSS); autonomous multi-modal mobile transport platform mission database (DMDB); device authentication authority (DAA); and autonomous multi-modal mobile transport platform mission checker (DMC). Individual Nodes will publish status and event information to the DDE at regular intervals. From this, the current state of the entire system will be built and updated. Users and customers have access to another service called the autonomous multi-modal mobile transport platform request system (DRS) through which they can hail services.

A autonomous multi-modal mobile transport platform flies or travels to the next of what may be multiple legs of the mission. A) It consults its itinerary to see which node is next; B) it communicates in an authenticated way to ensure that the next node is ready for its arrival; C) as it arrives at another node, it updates its schedule of commitments and activity logs; D) if along the way, the autonomous multi-modal mobile transport platform finds that it must update its itinerary because a node that had been included is no longer available, based on weather conditions associated with the route; air traffic associated with the route; no-fly zones associated with the route; availability of the smart drone autonomous multi-modal mobile transport platform for delivery of the payload, operating conditions of the smart drone autonomous multi-modal mobile transport platform; or delays associated with onboarding and unloading of the payload on the smart drone autonomous multi-modal mobile transport platform, it will ask the DFP to update the itinerary and the changes will be pushed to the affected downstream nodes; and E) when the autonomous multi-modal mobile transport platform arrives at the destination node, the delivery will be made, the end user will authenticate the receipt of the delivery via mobile app or mobile phone, the autonomous multi-modal mobile transport platform will open the smart container, smart mailbox landing pad or smart parcel mailbox landing pad, the receiving party, smart parcel mailbox landing pad or smart parcel mailbox landing pad will close the container or accept the disposable container, the autonomous multi-modal mobile transport platform missions database (DMDB) will be updated to record the finished mission, and the autonomous multi-modal mobile transport platform will either charge there or move on to a recharge station if the destination is not capable of recharging the node.

Weather, traffic, ATC, TFR, etc., causes a denial for UAS flight—should the UAS delivery not meet the permissions which provide an authentication for flight, the controller will provide for the following options by redirecting action to the vehicle fleet management (VFM) operating system module which offers four services: 1) Vendor in-house manned vehicle delivery service; 2) SDAS in-house autonomous unmanned ground vehicle (UGV) hailing service; 3) third-party manned vehicle API app hailing service; 4) third-party autonomous unmanned ground vehicle (UGV) hailing service using a third-party API app.

Unmanned System Services Network (USSN)—The USSN for the smart autonomous multi-modal mobile transport platform rooftop autonomous multi-modal mobile transport platform-port/airport is used to enable the communications necessary to support a robust autonomous multi-modal mobile transport platform or unmanned aerial vehicle (UAV), unmanned ground vehicle (UGV) or vertical take-off and landing vehicle (VTOL), etc. facilities. The USSN has been designed to achieve the following goals: A) flexibility:—the network is agnostic and can support a wide variety of data communications and platforms such as DaaS, IaaS, PaaS, SaaS, RaaS, and C-RAN, allowing for open platform integration and SDK software development; B) extensibility—new kinds of devices and components can be integrated into the network readily and inexpensively; C) security—all communications will be encrypted for confidentiality and signed so that components will authenticate themselves to the USSN and to each other; and D) performance—data exchange will occur efficiently when and where it is needed so that components can perform their intended functions.

USSN Architecture. The USSN consists of nodes and there are three types of nodes: controllers, rooftop clients (R-clients), and extended clients (E-clients). Each smart autonomous multi-modal mobile transport platform rooftop autonomous multi-modal mobile transport platform port/airport will employ one controller node and as many client nodes as the rooftop can accommodate based on government compliance and class approvals. The controller provides services to the client nodes and serves as the smart autonomous multi-modal mobile transport platform rooftop airport's central point of contact. The controller node sends commands and configuration information to the client nodes and receives data and service requests from them. The controller and client communicate with each other over a TCP-IP and or Wi-Fi Network. The controller node communicates with devices beyond the rooftop using a 4G, 4G LTE, or 5G mobile data network. FIG. 57 shows the design of a USSN using names of nodes in action.

USSN Controller Node Architecture. The Controller Node consists of an Internet-connected computer, authentication fob, GPS transmitter, and mobile network antenna. The computer and authentication fob are housed in a theft-proof, environmentally hardened container. The authentication fob is a USB key containing the controller's 160-bit identification number (ID) and private RSA key. The controller runs a modern commercial-grade operating system that hosts the following: 1) a Wi-Fi router with managed IP address assignment and configured for dynamic near real-time, real time and sub-real time full spectrum frequency hopping and a smart antenna; 2) a web server configured with the controller's public key certificate; 3) a database server; 4) a web application featuring a RESTful API, through which R-clients and E-clients may request reservations, data and other services; 5) an event logger; 6) a fees ledger for keeping track of takeoff and landing fees to collect; 7) an R-client inventory tool used to keep track of the R-clients that the controller manages; and 8) an R-client messenger tool for communicating instructions and data with R-clients.

USSN R-Client Part 1. An R-client is located on the rooftop with the controller. R-clients include non-optional and optional modular features from both the provisional patent filing incorporated herein, plus the integration options of: Rooftop Landing Pads, Rooftop Landing/Charging Stations, Rooftop Storage/Charging/DeIcing/Hanger Stations, Rooftop Delivery Storage Containers, Hail Pads, Rooftop Quick Change UAS Battery Stations, Air Navigation Service Provider Devices (ANSP) Systems, 4G, 4G LTE, and 5G Air to Ground and Air to Air Systems, Next GEN Weather Station Systems, Weather Data Equipment and Collection hubs (Anemometer, Thermometer, Barometer, Digital Rain Gauge, Lightning Detector, Automated Weather Observing Systems (AWOS), Automated Surface Observing System (ASOS), Automated Weather Sensor System (AWSS), Low Level Wind Shear Advisory System (LLWAS), Ceilometer), Frequency Hopping Spread Spectrum Radio (FHSS), Code Division Multiple Access (CDMA), RADAR, Light Detecting and Ranging (LiDAR), Infrared, Sonar Object Detection Device (SOD), Radio Frequency Device (RF), Radio Frequency Identification Devices (RFIDs), Static and Dynamic Quick Response Devices (QR Codes), Solar Panels, Active Digital Distributed Antenna System (DAS), Near Field Communication Antenna (NFC), Wireless Fidelity Wireless Internet System (WiFi), WiFi router, 4G, 4G LTE and 5G Devices, Global Positioning Transmitting System (GPS), Global Air Traffic Surveillance System Devices (GATSS), Inertial Reference System Devices (IRS), Unmanned Aerial System Service Supplier (USS), International Mobile Subscriber Identity (IMSI), Anti Catchers (Cell Tower Simulators) Systems, Wide Area Augmentation System (WAAS), NFC antenna, Bluetooth Antenna, Low Wind Antenna, C RAN Antenna System, Massive MIMO, Common Public Radio interfaces (CPRI), Baseband Unit (BBU), Base Station, Base Transceiver System (BTS), Coordinated Multi Point (CoMP), Beamforming Hardware, Transport Extension Nodes (TEN), Central Area Nodes (CAN), Carrier Access Point (CAP), Wide Area Integration Node (WIN), Voltage Standing Wave Radio (VSWR), Wireless Broadband, WiMAX, Zigbee Wireless Devices, Spectrum Access Systems (SAS), Multi-Tenant Data Center (MTDC), Citizens Broadband Radio System Device (CBRS), CUAS/CUAV, (Counter Anti-Drone Devices), Anti EMP Devices, Internet of Things Devices (IoT), Dedicated Short Range Communication Devices (DSRC), Autonomous multi-modal mobile transport platform to Autonomous multi-modal mobile transport platform Communication Devices (D2D), Autonomous multi-modal mobile transport platform Landing Pad Communication Devices (D2L), Autonomous multi-modal mobile transport platform to Infrastructure Communication Devices (D2I), Autonomous multi-modal mobile transport platform to Autonomous multi-modal mobile transport platform Single Hop Broadcasting Devices, Autonomous multi-modal mobile transport platform to Autonomous multi-modal mobile transport platforms Multi Hop Broadcasting Devices, Autonomous multi-modal mobile transport platform Platooning Devices, Sensors, Intelligent Lighting, Blockchain Devices, Telemetry Devices, Sky Cameras, Security Cameras, Vision Process Systems (VPS), Real World Interface (RWI), Extended Kalmen Filter (EKF), Simultaneous Localization and Mapping Devices (SLAM), Fast Lightweight Autonomy System (FLA), Random Sampling Consensus Devices (RANSAC), Laser Scanner, US Data Exchange Devices (USDE), Low Altitude Authorization and Notification Capability Devices (LAANC), Urban Air Mobility Eco System Devices (UAM), Real Time Locating System (RTLC), Asset Tracking Label System Devices (ATL), Barcodes, Servers, Auxiliary Energy Systems, Unmanned Traffic Management Devices (UTM), FANS 1, FANS 1/A Systems, FANS Router, FAN enabled Avionics, Edge Computing Systems, Cloud Systems, Multi Cloud Systems, Local Cloud Systems, Distributed Cloud Systems, Hybrid Cloud Systems, Compute Edge, Device Edge, and Sensor Edge Systems, Machine Learning Systems, Augmented Reality (AR)/Virtual Reality (VR)/Mixed Reality (MR) Systems, Artificial Intelligence (AI) Systems, High Performance Networking (HPN) Systems, Predictive Maintenance Systems, Asset Optimization Systems, cognitive analytic systems, Industrial Internet of Things (IoT) Automation Systems, Digital Operations Systems, DigitalOps Systems, DigiOps Systems, VMWare Systems, and Public and Workforce Safety and Efficiency Systems.

USSN R-Client Part 2. Satellite Based Augmented System (SBAS) integration modulation that supports Wide Area or Regional Augmentation Worldwide: A) North America-Wide Area Augmentation System (WAAS); B) Europe-European Geostationary Navigation Overlay Service (EGNOS); C) Japan-Multi-Functional Satellite Augmentation System (MSAS); D) India-GPS Aided Geo-Augmentation Navigation (GAGAN). The technology is a critical component of the FAA's Next Generation (NextGen) program and the EUROCONTROL SESAR initiative. “Upgrading” to SBAS involves replacing an existing flight management system (FMS) with a new SBAS-capable FMS. As an in-line replacement, the Universal Avionics SBAS-FMS constitutes minor changes to wiring, antennas, keying and configuration when certified for most LPV capabilities. Still, most of the existing wiring may be used. Non-LPV SBAS-FMS installations have lesser changes. However, direct installation of an SBAS on a UAS rooftop airport allows for use of the FAA's NextGen with no upgrading.

USSN R-Client Part 3. SBAS allows for national air space (NAS) integration of aircraft and helicopter transportation with UAS, UAV, VTOL, CTOL, STOL, heliport, vertiport, rooftop autonomous multi-modal mobile transport platform-port/airports integration modulation. Approved GPS position input sources in accordance with the appropriate TSO for integration with approved transponders for the ADS-B Out mandate compatible with SBAS around the world: WAAS, EGNOS, MSAS and GAGAN. This ensures compliance with precision-area navigation (P-RNAV). Key element of performance-based navigation (PBN) and required Navigation performance (RNP)/Area Navigation (RNAV). This allows for user-friendly use with more capabilities to reduce pilot workload for hybrid autonomous and manual pilots and increase flight operations efficiently for unmanned aircraft with every new universal avionics SBAS-FMS installation and major hardware upgrade. Enhanced safety provided with the latest TSOs more accurate SBAS and GPS information to the onboard TAWS/EGPWS and TCAS. This eliminates manual RAIM prediction requirements, incorporates high-speed ethernet technology that allows for faster data downloads via the Solid-State Data Transfer Unit (SSDTU). Low-level and high-level rooftop airports can provide for direct routing and direct approaches that eliminate the step-down type approaches. This will allow for shorter routing to secondary airports due to adverse weather conditions that will be provided by rooftop meteorology equipment and/or NAS available third-party services. Smart autonomous multi-modal mobile transport platforms will be equipped with ADS-B to have the ability to receive traffic information, weather data, and flight information. Virtual airways that may be designated by the Department of Transportation, FAA and/or other government entities for smart autonomous multi-modal mobile transport platforms will be integrated in USSN as a R-client virtual smart autonomous multi-modal mobile transport platform airway (VDA). The SDAS rooftop smart autonomous multi-modal mobile transport platform ports/airports will be able to seamlessly integrate with the key component of the universal avionics Future Air Navigation System (FANS) solution.

USSN R-Client Part 4. The FANS integration modulation will provide: A) an option for direct data link communication between the pilot, remote pilot and the air traffic controller (ATC); B) Aircraft Communications Addressing and Reporting System (ACARS) communications (satellite-based); C) Communication, Navigation, and Surveillance (CNS)/Air Traffic Management (ATM) for Air Traffic Service (ATS) providers; D) Data Link Service Providers (DSP)/Communication Service Providers (CSP). Radio or satellite technology (SatCom) issued to enable digital transmission of short, relatively simple messages between the aircraft, UAS, UAV, VTOL, CTOL, STOL, heliports, veriports and ground stations. Communications typically include the traditional air traffic control clearances, pilot requests, and position reporting. The goal of FANS is to improve performance related to communication, navigation and surveillance (CNS)/air traffic management (ATM) activities within the operation environment. Through a satellite data link integration feature, airplanes, autonomous multi-modal mobile transport platforms, UAS, UAV, and VTOL equipped with FANS can transmit Automatic Dependent Surveillance (ADS) reports with actual position and intent information at least every 5 minutes. This can provide for real-time enroute and re-route AI weather reporting from FANS and NextGen to and between airplanes, smart autonomous multi-modal mobile transport platforms, UAS, UAV, and VTOL aircraft.

USSN R-Client Part 5. Additional integration modulation for observation, prediction, UAS, UAV, VTOL, CTOL, STOL deployment and third-party services, that will be available with the assistance of UAS/UAV, VTOL, CTOL, STOL, meteorological, networking, and operating systems equipment on the SDAS smart autonomous multi-modal mobile transport platform-port/airport: A) information disseminated from the smart autonomous multi-modal mobile transport platform equipped with a smart autonomous multi-modal mobile transport platform anemometer and/or barometer an/or IMU, in order to create Smart Autonomous multi-modal mobile transport platform Aircraft Reports (AMDAR) that were deployed from the SDAS smart autonomous multi-modal mobile transport platform-port/airport. Common Support Services-Weather (CSS-Wx)—Which publishes info provided by the NextGen weather processor and use of the System Wide Information Management Network to the FAA and National Airspace System (NAS); B) Observations through the following: NextGen CCS-Observations-Satellite Imagery; Radar Imagery; Aircraft Reports (AMDAR); Surface Reports (METARS); Upper Air Reports (Balloon Soundings); Numerical Modeling; Statistical Forecasting—NWS Forecasters, Auto Forecast System and Forecast Integration; CoSpa: Consolidation Storm Prediction for Aviation; Storm Prediction Center (SPC); Smart Autonomous multi-modal mobile transport platform Weather Avoidance Field (WAF and UASWAF) Module—with Smart Autonomous multi-modal mobile transport platform Deviation Model and Forecast Smart Autonomous multi-modal mobile transport platform Avoidance Regions Models; Vortex 2 and 3—for Weather Chasing and Reporting with Smart Autonomous multi-modal mobile transport platforms; National Severe Storms Laboratories (NSSL); and Smart Autonomous multi-modal mobile transport platform Inhouse, Mesonet and or other third-party smart autonomous multi-modal mobile transport platform fleet data sharing; and other smart devices that collect data and send it to the controller and that may receive instructions from the controller.

USSN R-Client Hardware. Each R-client includes as part of its hardware the following: 1) a system-on-a-chip (SoC) computer, such as a Raspberry Pi, that is equipped with a WiFi Antenna; 2) a USB key that includes the R-client's 160-bit identification number and private key; 3) an R-client configuration manager that holds the 160-bit ID and public key of the controller; 4) an R-client messenger tool for communicating instructions and data with the controller; 5) a Wi-Fi router, NFC antenna, and or Bluetooth Antenna to communicate with other R-clients or, for Small Landing Pads/Smart Mailbox and Parcel Landing Pads, Smart Charging Stations, Hangers, HeliPort, VertiPorts for Smart Autonomous multi-modal mobile transport platforms (UAS, UAV, VTOL, etc.), that land on it or connect to it.

USSN E-Clients. An E-client is any remote device or application that requests or uses the services of the rooftop airport. Examples of E-clients include in-flight UAVs, POS systems, take away delivery apps, API apps, flight-hailing apps, public safety systems, Amber Alert Systems, weather-reporting systems and logistics operators. E-clients communicate with controllers to request services, request data, provide data, arrange flights, and coordinate landings.

Installing an SDAS rooftop autonomous multi-modal mobile transport platform-port/airport. The controller maintains an inventory of R-clients. R-clients include rooftop landing pads and other equipment discussed hereinabove associated with the autonomous multi-modal mobile transport platform services that share the roof. To install a new R-client the rooftop operator will: 1) register the R-client's 160-bit ID in the controller's R-client inventory system; 2) register the controller's ID and public key with the R-client's configuration manager; 3) assign the R-client a fixed IP address through the controller's WiFi router; and 4) install the R-client messenger tool on the R-client and configure it to communicate with the controller.

Reserving and Implementing a Takeoff Part 1. A remote requestor uses a web browser or mobile app to connect to the controller's reservations homepage. User, pilot and/or controller specifies “takeoff request” or “departure request” as the type of transaction, which of the controller's available autonomous multi-modal mobile transport platform models to schedule, destination GPS, and type of payload. The controller scans its inventory of available autonomous multi-modal mobile transport platforms to identify a match. After asking for and receiving confirmation from the remote requestor, including payment of the fees associated with the takeoff, the controller, at the designated takeoff time, sends GPS coordinates of the selected UAV's destination to the UAV's host pad through the R-client messenger tool. The host pad communicates the GPS coordinates to the UAV and initiates the takeoff. The host pad notifies the controller that the takeoff or departure occurred. The controller logs the event in its schedule and resets the R-client landing pad's status to available.

Reserving and Implementing Takeoff Part 2. A remote requestor uses a web browser or mobile app, such as a Smart Autonomous Multi-modal Mobile Transport Platform app, to connect to the controller's reservations homepage. 1) S/he specifies “takeoff request” as the type of transaction; 2) to which of the controller's available smart autonomous multi-modal mobile transport platform models to schedule, destination GPS, and type of payload; 3) the controller scans its inventory of available smart autonomous multi-modal mobile transport platforms to identify a match; 4) after asking for and receiving confirmation from the remote requestor, including payment of the fees associated with the takeoff, the controller, at the designated takeoff time, sends GPS coordinates of the selected UAV's destination to the UAV's host pad through the R-client messenger tool; and 5) the host pad communicates the GPS coordinates to the UAV and initiates the takeoff. The host pad notifies the controller that the takeoff occurred. The controller logs the event in its schedule and resets the R-client landing pad's status to available.

USSN Other Data Requests. Besides landing pads, a rooftop may contain other R-clients whose services and/or data E-clients may request. For example, service providers may request low altitude weather data from NextGen weather measurement and data collection devices. To request data from R-clients, a would-be consumer will access the controller's web page to request the desired service/data set. It is up to the owner/configurator of the controller to decide which services to make available to which E-clients and to implement the communications needed to provide the service. Based on that configuration, the controller and R-client will coordinate fulfilling the E-client's request. The controller serves as the initial point of contact that authenticates and then fulfills the request, In-house and third-party APIs can be customized for customer needs as well.

USSN System Network and Cyber Architecture Platform. This is the entire platform integration of the: 1) microservices platform agnostic; 2) cybersecurity reference architecture; 3) corporate data center; 4) AWS security and cloud diagram; and 5) USSN node system hardware and software diagram.

All portable autonomous multi-modal mobile transport platform landing pads are a part of the infrastructure and shall have, in addition to the owner of record's address, the longitude and latitude quadrants and GPS location of the portable landing at the time of its request and use. In some embodiments, a flight plan, dispatch approval (manual and/or automated), and payload/cargo manifest will be digitally logged and uploaded via cloud computing systems known in the arts to all required authorities/agencies and/or vendor/servicer participants for any UAS/autonomous multi-modal mobile transport platform flight executed for service and or delivery.

Up to two alternate routes may be provided by an algorithm and/or artificial intelligence (AI) for best in-route flight results based on all variables necessary and that can affect a safe UAS/autonomous multi-modal mobile transport platform flight, such as weather, traffic, availability, inoperability, unforeseen delays, no-fly zones, and the like. Upon confirmed matches of all above IP and physical addresses assigned to such owners of record via the UAS/autonomous multi-modal mobile transport platform operating system, the autonomous multi-modal mobile transport platform mobile and online applications, and any other means of consumer private and commercial public use and request may proceed with its routes.

In some embodiments, SDAS autonomous multi-modal mobile transport platform landing pad stations and rooftop UAS autonomous multi-modal mobile transport platform-ports/airports will have an option that allows for weather descriptor codes to be relayed and translated by cloud computing automation and big data to the appropriate receiving location in need of it for important to automated flight decisions, data harvesting, mining, dissemination, and storing. Additional description of the USSN system and its functionality is described within the parent application U.S. patent application Ser. No. 16/866,484, titled “SMART DRONE ROOFTOP AND GROUND AIRPORT SYSTEM,” and filed on May 4, 2020.

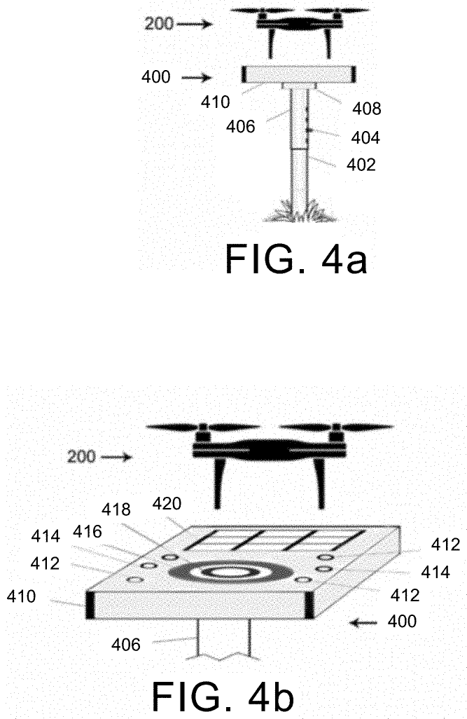

FIGS. 4a-b illustrate an example embodiment of a smart autonomous multi-modal mobile transport platform landing station for a system providing custom advertising and brand wraps for smart autonomous multi-modal mobile transport platforms according to the present invention. The autonomous flying devices (smart autonomous multi-modal mobile transport platform) 200 travel from vendor establishments to customers to deliver items that have been ordered for delivery. The autonomous flying devices 200 land upon a landing pad assembly 100 in order to permit customers to retrieve purchased items from within an attached container of the autonomous flying devices 200.

FIG. 4a shows a non-descriptive UAV vehicle 200 hovering directly above the landing pad assembly 100. The landing pad assembly 100 is mounted to the ground utilizing a support tube 402 in accordance with the present invention. The assembly 400 includes a support tube 402, quick release pin 404, telescoping tube 406, tube to pad adapter 408, landing pad assembly 410, landing sensors 412, beacon lights 414, near field communication (NFC) transmitter/receiver 416, wireless fidelity/wireless internet (WiFi) system 418, and solar panel 420.

FIG. 4b shows a non-descriptive UAV vehicle 200 hovering directly above the landing pad assembly 400. Moreover, the figure shows the top surface of the landing pad assembly 410, displaying its functional features. Imbedded into the assembly 400 is a solar panel 420 designed to provide the assembly 400 with uninterrupted electrical power. When functional, the landing pad 410 utilizes the imbedded NFC transmitter/receiver 416 and the built-in WiFi 418 systems to establish the radio data communication with the incoming UAV 200. These systems are designed to guide the incoming UAV 200 to the landing pad 410 utilizing GPS. Upon approach to the assembly 400, the UAV 200 can rely on the landing pad's 410 built-in landing sensors 412 and the beacon lights 414 to guide it to the final landing position. The entire process is controlled/monitored by the end-user via readily available electronic devices, such as smart phones, tablets, and laptops.

The landing pad 410 was also designed with various public facilities and government agencies in mind. Accordingly, the landing pad 410 can be easily adapted for use on military installations, law enforcement facilities, airports, schools, hospitals and various other public properties. The landing pad 410 can be attached to a top surface of any existing structure, or by utilizing the tube to pad adapter 408 as shown in FIG. 4a.

The landing pad assembly 400 depicted in FIG. 4a, shows several new improvements applicable to both a portable version of the landing pad 400 and a stationary version of the landing pad 400. The first improvement addresses the existing solar panel unit 420 of the landing pad 400. As described in 4a, the solar panel 420 was primarily designed to charge the landing pad 400 and its internal systems. These systems, specifically the WiFi communications system 418, the landing pad sensors 412, and the beacons 414, assist the autonomous multi-modal mobile transport platform 200 in locating the landing pad 100 and provide guidance during the landing process. The new solar panel 420 will not only provide the energy for the internal systems of the landing pad 400, but it will also serve as a charging station for any autonomous multi-modal mobile transport platform 200 utilizing the landing pad 400 itself. It is important to note that the landing pad assembly 400, both portable and stationary, is not strictly dependent on the solar panel 420 for its power supply. The landing pad 400 may also draw its power directly from the nearby source of alternating current by utilizing an optional power cord. If the alternating current is not available, the landing pad 400 may draw its power from an optional, portable battery pack supplying an appropriate level of direct current to power the assembly and its components.

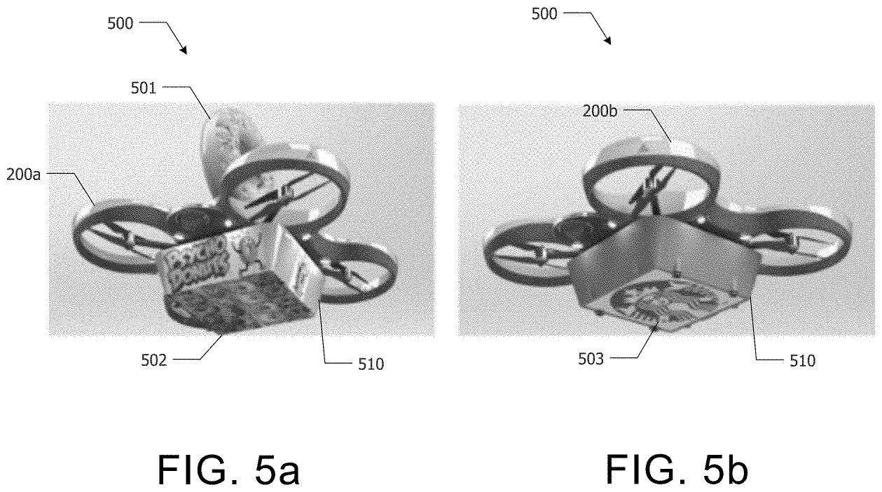

FIGS. 5a-b illustrate an example embodiment of a smart autonomous multi-modal mobile transport platform having custom advertisements for a system providing custom advertising and brand wraps for smart autonomous multi-modal mobile transport platforms according to the present invention. FIG. 5a shows a smart autonomous multi-modal mobile transport platform 200 having customized advertising wraps 502 attached to a product container 510 used to transport items from a vendor to a customer. The customized wraps 502 may consist of easily applied film containing images, videos, text, logos, trademarks, branding information and related advertising material visible by customers and nearby individuals when the smart autonomous multi-modal mobile transport platform 200 is both picking up items from a vendor's establishment as well as landing at a landing pad 400 permitting a customer to obtain a purchased item.

The images, text, logos, trademarks, brands and related advertising material may be associated with a particular vendor, such as a large fast-food chain, that uses the smart autonomous multi-modal mobile transport platforms 200a as part of its delivery services. In such a case, the images, text, logos, and related advertising material containing film 502 may be applied and a particular autonomous multi-modal mobile transport platform 200a may be utilized for deliveries just for this particular restaurant/chain. Because the film materials 502 are readily removable without damaging the smart autonomous multi-modal mobile transport platform 200a, the smart autonomous multi-modal mobile transport platform 200a may be periodically repurposed by changing the film 502 from one vendor to another. Additionally, the film 502 may be tailored to support a single vendor with images, text, logos, and related advertising material film 502 that change over time. For example, many restaurants may provide special products and offers associated with various seasons. As such, the restaurant may wish to utilize autonomous multi-modal mobile transport platforms that show different images, text, logos, and related advertising material film 502 for the end of the year holiday season that is different than back to school, summertime, and similar seasons.

FIG. 5a also shows that the smart autonomous multi-modal mobile transport platform 200a may possess an advertising example 501 such as an artificial donut that is mounted on top of the autonomous multi-modal mobile transport platform 200a when this particular autonomous multi-modal mobile transport platform is providing delivery services for a donut establishment. As noted above, the product container 510 may be removable to deliver items to a customer as the autonomous multi-modal mobile transport platform 200a may separate from the product container 510. The product container 510 typically mounts to a bottom side of the autonomous multi-modal mobile transport platform 200a and as such, the advertising example 501 may be an item that is mounted to a top surface of the autonomous multi-modal mobile transport platform 200a typically between the device's rotors. The advertising example 501 may be configured to permit it to be easily attached and removed from the autonomous multi-modal mobile transport platform 200a as desired.

FIG. 5 b shows a smart autonomous multi-modal mobile transport platform 200b that provides images, text, logos, and related advertising material on an electronic billboard display 503. The electronic billboard display 503 may be mounted on one or more of the outside surfaces of the product container 510 and display its images, text, logos, and related advertising material while making a delivery. When the smart autonomous multi-modal mobile transport platform 200b picks up an item for delivery from a vendor establishment, the smart autonomous multi-modal mobile transport platform 200b may be provided a particular set of images, text, logos, and related advertising material that are to be displayed onto one or more of the electronic billboard displays 503 during a current delivery. The smart autonomous multi-modal mobile transport platform 200b may send a push notification to the customer, where payment for the one or more advertising messages or the more digital brand marks can be made by credit card payment, fiat payment, a digital wallet with cryptocurrency and/or tokens for payment in addition to credit cards and fiat payments, and redemption of a delivered advertisement, promotional messages and/or digital coupons are stored in the digital wallet and/or used at a different time. Flying over people with push notification of the ads they offer being airdropped into the customer's mobile device. Where payment for advertising can be made by digital wallet with crypto and/or tokens for payment in addition to credit cards and fiat payments. Redemption of the airdrop ad/promo/digital coupon that is airdropped can be stored in a digital wallet and our used at a different time to redeem. While flying over people, the smart autonomous multi-modal mobile transport platform 200b may send a push notification of the ads they offer being airdropped into the customer's mobile device. Payment for advertising can be made by digital wallet with crypto and or tokens for payment in addition to credit cards and fiat payments. Redemption of the airdrop ad/promo/digital coupon that is airdropped can be stored in a digital wallet and our used at a different time to redeem.

Participating mobile devices can receive the same ad on their mobile device that is on the digital monitor that offers digital, video, audio, dynamic and static advertising with its built-in monitor(s) and or decals. Both physical and digital airdrop advertisements can be done with the smart drone autonomous multi-modal mobile transport platform.

Once the delivery is complete, the smart autonomous multi-modal mobile transport platform 200b may receive instructions to proceed to a different vendor establishment to pick up another delivery. This different vendor may possess a different set of images, text, logos, and related advertising material that are to be displayed for the subsequent delivery. The images, text, logos, and related advertising material may be delivered electronically to the smart autonomous multi-modal mobile transport platform 200b along with the next travel instructions.

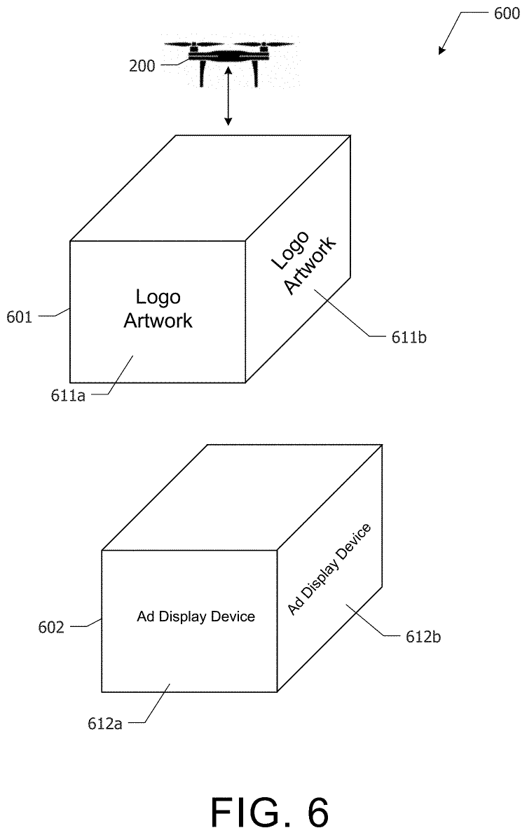

In other embodiments, the electronic billboard displays 503 may present various different sets of images, videos, text, logos, trademarks, branding information and related advertising material that may change as the smart autonomous multi-modal mobile transport platform 200b transits from one location to another. These images, videos, text, logos, trademarks, branding information related advertising material may be advertisements associated with the vendor currently being serviced, may be associated with any other vendor purchasing the advertisement time on the electronic billboard displays 503, or an alternating combination of both sets of images, text, logos, and related advertising material. Participating mobile devices can receive the same ad on their mobile device that is on the digital monitor that offers digital, video, audio, dynamic and static advertising with its built-in monitor(s) and or decals. The electronic billboard display 503 of FIG. 5b is shown just on the bottom surface of the product container 510 as that surface is most readily visible as the autonomous multi-modal mobile transport platform transits between locations; however, additional electronic billboard displays 503 may be positioned upon the various sides of the product container 510 as disclosed below in reference to FIG. 6.

FIG. 6 illustrates an example embodiment of a smart autonomous multi-modal mobile transport platform having custom advertisements on removable storage containers used by smart autonomous multi-modal mobile transport platforms according to the present invention. FIG. 6 shows a smart autonomous multi-modal mobile transport platform 200 along with a pair of product containers 601-602 that may be coupled to the autonomous multi-modal mobile transport platform 200 as needed. A first product container 601 shows a set of images, videos, text, logos, trademarks, branding information and related advertising material 611a-b on multiple sides of the product container 601. These sets of images, videos, text, logos, trademarks, branding information and related advertising material 611a-b may be attached to any of the outside surfaces, including the bottom surface as shown in FIG. 5b, as desired.

Similarly, a second product container 602 shows a set of images, videos, text, logos, trademarks, branding information and related advertising material 612a-b displayed on multiple electronic billboard displays 503 that are also located on each of the outside surfaces of the product container 602. The number of electronic billboard displays 503 may be varied depending upon the needs and desires of the operator of the smart autonomous multi-modal mobile transport platforms 200 as the additional multiple electronic billboard displays adds weight to a smart autonomous multi-modal mobile transport platform 602 as well as consumes electrical energy stored within the smart autonomous multi-modal mobile transport platform 602 that may limit the range of travel for a particular smart autonomous multi-modal mobile transport platform 602.

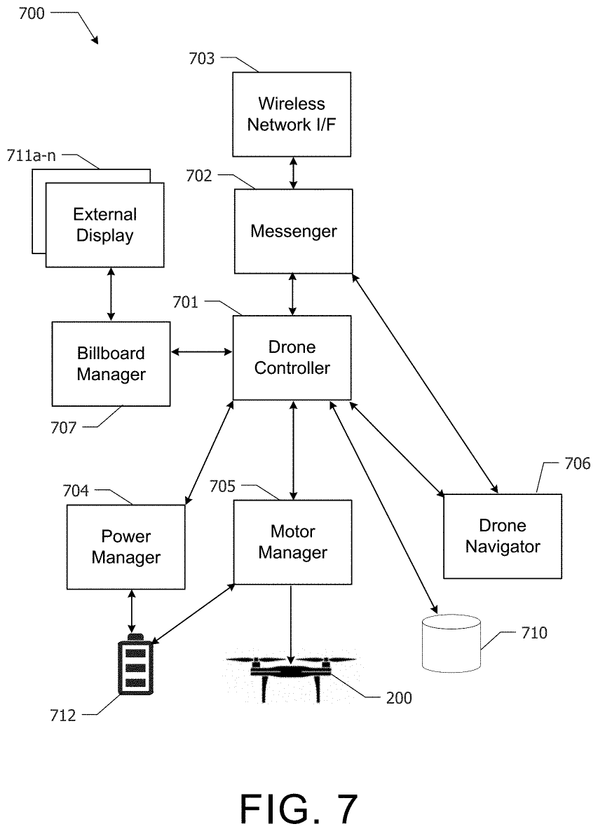

FIG. 7 illustrates a computing system of software components of a system providing custom advertising and brand wraps for smart autonomous multi-modal mobile transport platforms according to the present invention. FIG. 7 shows a set of computing components used within a smart autonomous multi-modal mobile transport platform 200 having electronic billboard displays 503 as disclosed above. The set of software components include a smart autonomous multi-modal mobile transport platform controller 701, a messenger 702, a wireless network interface 703, a power manager 704, a motor manager 705, a smart autonomous multi-modal mobile transport platform navigator 706, a billboard manager 707, local data storage 710, and one or more display devices 711a-n.

The smart autonomous multi-modal mobile transport platform controller 701 receives delivery commands and any related images, text, logos, and related advertising material data 502 via the wireless network interface 703 from the autonomous multi-modal mobile transport platform airport system (DAS) 100 and its various processing systems. The autonomous multi-modal mobile transport platform controller 701 also obtains current location data from the autonomous multi-modal mobile transport platform navigator 706 for use in moving the smart autonomous multi-modal mobile transport platform 200 from the vendor establishments to customers landing pads 400. The autonomous multi-modal mobile transport platform controller 701 also interacts with the remaining agent set of processing components to cause the smart autonomous multi-modal mobile transport platform 200 to transit from one location to another to both pick up items from vendor establishments as well as deliver these items to customers as needed.

The messenger 702 assists the smart autonomous multi-modal mobile transport platform 200 to send and receive data over the wireless network 110. The autonomous multi-modal mobile transport platform controller 701 communicates with processing components within the DAS 100 to obtain orders and associated destinations, to obtain images, text, logos, and related advertising material data 502 via the wireless network interface 703, status, health and location information periodically to permit the DAS 100 to monitor the activity of the smart autonomous multi-modal mobile transport platform 200. This communication is performed with the exchange of commands and related messages that are generated, monitored, and acknowledged by the messenger 702 to maintain communications with the DAS 100 as needed.

The wireless network interface 703 permits the smart autonomous multi-modal mobile transport platform controller 701 and other components to communicate with remote computing devices that are part of the DAS 100 and its various processing systems. The wireless network interface 703 performs all of the data formatting, computer-to-computer communications, encryption processing, and all similar operations needed by the smart autonomous multi-modal mobile transport platform controller 701 and the DAS 100 and its various processing systems to communicate with each other as needed.

The power manager 704 manages the power consumption from an internal battery that powers both the smart autonomous multi-modal mobile transport platform controller 701, the motor and motor manager 705, and the one or more display devices 711a-n. The smart autonomous multi-modal mobile transport platform 200 needs to control any power consumption to ensure the device may be capable of returning to a autonomous multi-modal mobile transport platform airport as shown in FIG. 1. The smart autonomous multi-modal mobile transport platform 200 will consume power in communications to and from the DAS 100. The smart autonomous multi-modal mobile transport platform 200 consumes power to operate the motors that enable the smart autonomous multi-modal mobile transport platform 200 to fly. The smart autonomous multi-modal mobile transport platform 200 also consumes power to display advertisements on the one or more display devices 711a-n. The power manager 704 monitors the current level of charge remaining in any internal batteries, the rate of consumption of the charge from the batteries currently being experienced, and an estimate of the remaining flight time to a customer landing pad 400 and then to return to a autonomous multi-modal mobile transport platform airport landing pad 103. The power manager 704 may control the number of display devices 711a-n in use as part of reducing power consumption as needed.

The motor manager 705 operates the rotors on a quadcopter-based smart autonomous multi-modal mobile transport platform 200 to control its motion, speed, and power consumption. The motor manager 705 monitors the rate of travel based upon changing location data generated within the autonomous multi-modal mobile transport platform navigator 706 to determine whether the smart autonomous multi-modal mobile transport platform 200 is making adequate progress to reach its destination in a required time allotted. The motor manager 705 may adjust the speed of rotation for each of the rotors to cause the smart autonomous multi-modal mobile transport platform 200 to travel in a desired direction and a defined altitude while moving at a specified rate of travel.

The smart autonomous multi-modal mobile transport platform navigator 706 determines a current position of the smart autonomous multi-modal mobile transport platform 200 for use by the various software components within the autonomous multi-modal mobile transport platform as well as communicated to the DAS 100 for monitoring the activity of the smart autonomous multi-modal mobile transport platform 200. The autonomous multi-modal mobile transport platform navigator 706 may obtain the current position using a GPS receiver within the smart autonomous multi-modal mobile transport platform 200. The smart autonomous multi-modal mobile transport platform navigator 706 may also determine the current position by triangulating the relative positions of various cellular signal towers used for wireless communication. Each of the cell towers typically provides its current position and by knowing the location of multiple towers and their relative position from the smart autonomous multi-modal mobile transport platform 200, a current position may be determined. The smart autonomous multi-modal mobile transport platform navigator 706 may also attempt to maintain its current position using a known starting point and a measurement of any changes in position observed as the smart autonomous multi-modal mobile transport platform 200 moves from location to location. Any other know mechanism to obtain a current position that may be provided to the smart autonomous multi-modal mobile transport platform controller 701 may also utilized within the smart autonomous multi-modal mobile transport platform navigator 706.

The billboard manager 707 obtains the image and video data to be displayed upon the billboard displays from the smart autonomous multi-modal mobile transport platform controller 701 that is stored within the local data storage 710 upon receipt from the DAS 100. The billboard manager 707 operates based upon commands from the smart autonomous multi-modal mobile transport platform controller 701. These commands include the type of data to be displayed upon the one or more display devices 711a-n, the timing for any changes to be made to the images and video displayed upon the one or more display devices 711a-n, and commands generated by the power manager 704 to ensure the smart smart autonomous multi-modal mobile transport platform 200 has sufficient stored charge within its internal batteries to return to a smart autonomous multi-modal mobile transport platform airport landing pad 103.

Local data storage 710 provides the smart autonomous multi-modal mobile transport platform controller 701 semi-permanent data storage to maintain order, travel, location, and advertisement data that is used by the various software components of the smart autonomous multi-modal mobile transport platform 200. The smart autonomous multi-modal mobile transport platform controller 701 may store this data when received from the DAS 100 and retrieve the data as needed to provide the data to the appropriate software component. The local data storage may be any mass storage device such as disk drives, solid state data storage devices, and the like.

One or more display devices 711a-n are image and video display devices that receive advertising data from the billboard manager 707 to provide custom advertisements on the smart autonomous multi-modal mobile transport platform 200 during its use. These display devices 711a-n may be activated and disabled as needed as controlled by the billboard manager 707.

The above set of computing components 701-707 may represent just a subset of the software within a smart autonomous multi-modal mobile transport platform 200. The set of computing components 701-707 are disclosed herein as these components may be relevant to the functionality of the present invention. Additional details regarding a smart autonomous multi-modal mobile transport platform 200 is disclosed within the parent application U.S. patent application Ser. No. 16/866,484, titled “SMART DRONE ROOFTOP AND GROUND AIRPORT SYSTEM,” and filed on May 4, 2020, cited above.

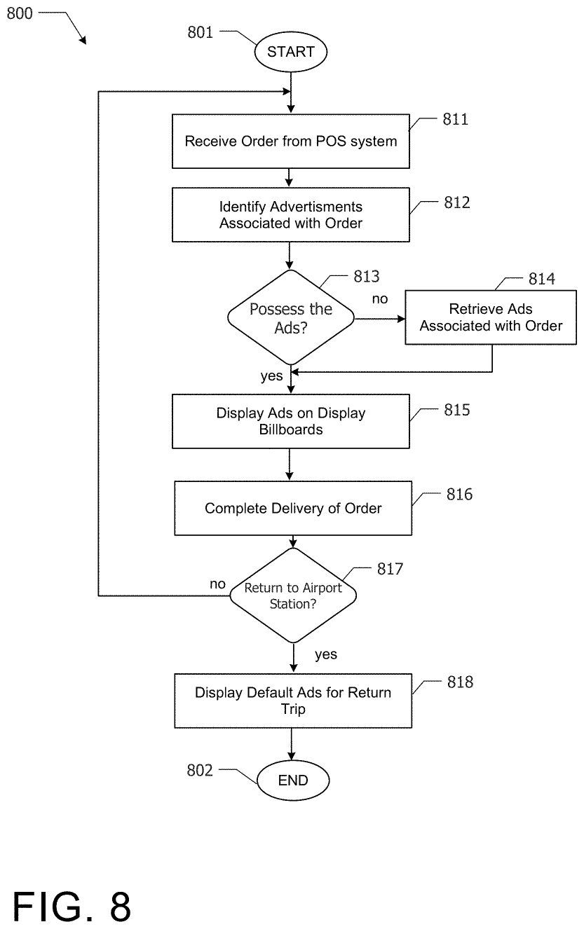

FIG. 8 illustrates a flowchart corresponding to a method performed by software components of a system providing custom advertising and brand wraps for smart autonomous multi-modal mobile transport platforms according to the present invention. The process 800 begins 801 when a smart autonomous multi-modal mobile transport platform 200 receives an order to pick up an item from a vendor establishment and deliver the item to a customer's landing pad 400 in step 811. In step 812, the smart autonomous multi-modal mobile transport platform 200 identifies any advertisements that are to be displayed during the upcoming flight. The smart autonomous multi-modal mobile transport platform 200 may determine the advertisements based upon the vendor's identification, the item to be transported, and commands contained within the order itself.

The smart autonomous multi-modal mobile transport platform 200 determines in test step 813 whether or not the images and video to be displayed during the upcoming flight are stored within the local storage 710 coupled to the smart autonomous multi-modal mobile transport platform controller 701; and if not, the smart autonomous multi-modal mobile transport platform retrieves the advertisement data in step 814. Once the smart autonomous multi-modal mobile transport platform 200 possesses the advertisement data, the advertisement data may be displayed upon the one or more display devices 711a-n in step 815. The billboard manager 707 may periodically change the images and video being displayed as instructed by the autonomous multi-modal mobile transport platform controller 701 or by the order itself.

The smart autonomous multi-modal mobile transport platform 200 continues its flight until the item is delivered to the customer landing pad 400 in step 816. Flying over people with push notification of the ads they offer being airdropped into the customer's mobile device. Where payment for advertising can be made by digital wallet with crypto and or tokens for payment in addition to credit cards and fiat payments. Redemption of the airdrop ad/promo/digital coupon that is airdropped can be stored in a digital wallet and our used at a different time to redeem.

Once the delivery is completed, the smart autonomous multi-modal mobile transport platform, in test step 817, determines whether or not the smart autonomous multi-modal mobile transport platform 200 is to return to the autonomous multi-modal mobile transport platform airport landing pad 103, or whether the smart autonomous multi-modal mobile transport platform is to perform an additional delivery. The smart autonomous multi-modal mobile transport platform 200 may make this determination within test step 817 based upon command messages received from the DAS 100, based upon its location relative to a subsequent item to be picked up for delivery, and upon the amount of charge remaining within the internal batteries of the smart autonomous multi-modal mobile transport platform 200. When the smart autonomous multi-modal mobile transport platform 200 determines in test step 817 that it is to perform an additional delivery, the process 800 returns to step 811 to obtain the next order information and repeat the above delivery process.

When the smart autonomous multi-modal mobile transport platform 200 determines in test step 817 that it is to return to its nearest autonomous multi-modal mobile transport platform airport landing pad 103, the smart autonomous multi-modal mobile transport platform in step 818 displays the default advertisement data onto the one or more display devices 711a-n for the return trip. The process ends 802 when the smart autonomous multi-modal mobile transport platform 200 reaches its nearest autonomous multi-modal mobile transport platform airport landing pad 103.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), and transfer of content(s) or data between any combination of the components.

What is claimed is:

1. A system for providing custom advertising and brand wraps for a smart autonomous multi-modal mobile transport platform, the system comprising:
one or more smart autonomous multi-modal mobile transport platforms, operable to carry a payload for delivery to a first destination; and
a memory storage, in communication with the one or more smart autonomous multi-modal mobile transport platforms, UAVs, UASs, VTOLs, eVTOLs, UGVs, and or ground robots, and operable to store one or advertisements associated with the payload, where the smart autonomous multi-modal mobile transport platform comprises one or more displays connected to the smart autonomous multi-modal mobile transport platform and where the one or more displays are configured to display the one or more advertisements associated with the good.

2. The system of claim 1, where the smart autonomous multi-modal mobile transport comprises at least one of the following: an unmanned aircraft system (UAS), an unmanned aircraft vehicle (UAV), a vertical take-off and landing vehicle (VTOL), electric vertical take-off and landing vehicle (EVTOL), a vertical short take-off and landing vehicle (VSTOL), a short take-off and landing vehicles (STOL), an electric take-off and landing vehicle (eSTOL), a conventional take-off and landing vehicle (CTOL), an electric take-off and landing vehicle (eCTOL), an autonomous vehicles (AV), a connected and autonomous vehicles (CAV), a passenger air vehicle (PAV), an electric passenger air vehicles (ePAV) or, a robotic UAV/UAS, autonomous ground transport vehicles or a ground robotic platform.

3. The system of claim 1, where the payload comprises at least one of the following: a less than load delivery (LTL); a document delivery; a distribution center delivery; a freight on board (FOB) delivery; a cost, insurance, and freight delivery; a cost, no insurance, freight (CNF) delivery; a rideshare package delivery; a rideshare person delivery; a ride hailing; an on-demand location- and service-based UAS/smart autonomous multi-modal mobile transport platform hiring; a private and public use hiring; a take away delivery; parking, storing, garaging, charging, de-icing, anti-icing, and docking; warehousing delivery; a customs and port security delivery drop off; a perishable and/or non-perishable food and product delivery; a special product temperature and packaging delivery; the delivery of people and/or cargo.

4. The system of claim 1, further comprising an artificial intelligence module, the artificial intelligence module configured to determine a route for delivery of the payload based on at least one of the following: weather conditions associated with the route; air traffic associated with the route; no-fly zones associated with the route; availability of the smart autonomous multi-modal mobile transport platform for delivery of the payload, operating conditions of the smart autonomous multi-modal mobile transport platform; or delays associated with onboarding and unloading of the payload on the smart autonomous multi-modal mobile transport platform.

5. The system of claim 1, further comprising a smart landing pad assembly operable to permit a customer to retrieve the payload from the smart autonomous multi-modal mobile transport platform.

6. The system of claim 5, where the payload is stored within an attached container comprising a compartment of the smart autonomous multi-modal mobile transport platform or a compartment positioned external to the smart autonomous multi-modal mobile transport platform.

7. The system of claim 1, where the one or more advertisements comprise a physical advertising sample positioned on a top surface of the smart autonomous multi-modal mobile transport platform.

8. A method for providing advertising and brand wraps for smart autonomous multi-modal mobile transport platforms, the method comprising:
receiving an order for a good from a point-of-sale system to be delivered by the smart autonomous multi-modal mobile transport platform;
identifying one or more advertisements associated with the order;
responsive to determining if the one or more advertisements are stored locally, displaying the one or more advertisements on a display connected to the smart autonomous multi-modal mobile transport platform;
responsive to determining if the one or more advertisements are not stored locally, retrieving the one or more advertisements from an advertisement storage and displaying the one or more advertisements from remote storage on a display connected to the smart autonomous multi-modal mobile transport platform; and
completing the order for the good.

9. The method of claim 8, further comprising the smart autonomous multi-modal mobile transport platform returning to a smart autonomous multi-modal mobile transport platform rooftop and ground airport; and displaying one or more default ads on the display connected to the smart autonomous multi-modal mobile transport platform.

10. The method of claim 8, where displaying the one or more advertisements comprises displaying the one or more advertisements on a display screen positioned on the undercarriage of the smart autonomous multi-modal mobile transport platform.

11. The method of claim 8, where displaying the one or more advertisements comprises displaying the one or more advertisements on a wrap-around display screen, where the wrap-around display screen is positioned with a display screen on each vertical side of the smart autonomous multi-modal mobile transport platform.

12. The method of claim 8, where displaying the one or more advertisements comprises displaying a physical advertising sample of a top surface of the smart mobile transport platform.

13. The method of claim 8, where the smart autonomous multi-modal mobile transport platform comprises at least one of the following: an unmanned aircraft system (UAS), an unmanned aircraft vehicle (UAV), a vertical take-off and landing vehicle (VTOL), electric vertical take-off and landing vehicle (EVTOL), a vertical short take-off and landing vehicle (VSTOL), a short take-off and landing vehicles (STOL), an electric take-off and landing vehicle (eSTOL), a conventional take-off and landing vehicle (CTOL), an electric take-off and landing vehicle (eCTOL), an autonomous vehicles (AV), a connected and autonomous vehicles (CAV), a passenger air vehicle (PAV) an electric passenger air vehicles (ePAV) or, a robotic UAV/UAS, autonomous ground transport vehicles or a ground robotic platform.

14. The method of claim 8, further comprising:
responsive to receiving a second order for a second good from a point-of-sale system, determining, by an artificial intelligence module, a second destination for delivery of the second good based upon a remaining battery use of the smart autonomous multi-modal mobile transport platform; and
departing for the second destination.

15. A method for providing custom advertisements or brand wraps associated with a payload delivered by a smart autonomous multi-modal mobile transport platform to a customer, the method comprising:
receiving instructions to deliver the payload from a payload source location to a customer destination location;
determining, by an artificial intelligence module, one or more routes associated with delivery of the payload;
retrieving one or more advertising messages or one or more brand marks, the one or more advertising messages or the one or more brand marks associated with the payload;
displaying the one or more advertising messages or one or more brand marks on a display monitor attached to the smart autonomous multi-modal mobile transport platform, sending a push notification to the customer, where payment for the one or more advertising messages or the one or more digital brand marks can be made by credit card payment, fiat payment, a digital wallet with cryptocurrency and/or tokens for payment in addition to credit cards and fiat payments, and redemption of a delivered advertisement, promotional messages and/or digital coupons are stored in the digital wallet and/or used at a different time;
delivering the payload to the customer; and
determining, by the artificial intelligence module, a next destination location for the smart autonomous multi-modal mobile transport platform.

16. The method of claim 15, where the artificial intelligence module is operable to determine an optimum route based on at least one of the following: weather conditions associated with the route; air traffic associated with the route; no-fly zones associated with the route; availability of the smart autonomous multi-modal mobile transport platform for delivery of the payload, operating conditions of the smart mobile transport platform; delays associated with onboarding and unloading of the payload on the smart mobile transport platform, information associated with emergency announcements, missing person alerts or crime notification warnings.

17. The method of claim 16, where the artificial intelligence module is operable to continuously determine the optimal route during travel to the customer destination location.

18. The method of claim 16, where displaying the one or more advertising messages or one or more brand marks comprises displaying the one or more advertising messages or one or more brand marks on a series of display screens, the series of display screens attached to a plurality of positions along a vertical side of the smart mobile transport platform, where a participating mobile device receives the one or more advertising messages or one or more brand marks, the participating mobile device configured to receive and display digital, video, audio, dynamic and static advertising messages or brand marks.

19. The method of claim 16, where delivering the payload comprises delivering the payload in an external container either a part of the autonomous multi-modal mobile transport platform or detachable to it, carried by the smart mobile transport platform.

20. The method of claim 16, where displaying the one or more advertising messages or one or more brand marks comprises displaying a physical article or digital package associated with the one or more advertising messages or one or more brand marks, and/or delivering the physical article or digital package.
